(19) United States
(12) Patent Application Publication
(10) Pub. No.: US 2014/0023982 A1
(43) Pub. Date: Jan. 23, 2014

(54) SKELETAL ANCHORAGE DEVICE

(71) Applicant: Enrico PASIN, Bad Reichenhall (DE)

(72) Inventor: Enrico PASIN, Bad Reichenhall (DE)

(21) Appl. No.: 13/933,649

(22) Filed: Jul. 2, 2013

(30) Foreign Application Priority Data
Jul. 23, 2012 (DE) 10 2012 014 527.6

(51) Int. Cl. A61C 8/00; A61C 7/00

(52) U.S. Cl. CPC A61C 8/0096; A61C 7/00; A61C 8/0022
USPC 433/18

(57) ABSTRACT

The skeletal anchorage device according to the invention for attaching at least one orthodontic element to be used for orthodontic treatment comprises an anchorage element (10) which has an anchorage section (12) that is arranged to be attached skeletally, and also has an attachment section (14) that is arranged to be coupled with the at least one orthodontic element.

According to the invention, the attachment section (14) is provided with an attachment arrangement that is designed such that the orthodontic element may be clamped to the attachment section (14) with continually adjustable clamping force at least in certain sections.

The invention relates to a skeletal anchorage device for attaching at least one orthodontic element to be used for orthodontic treatment, wherein the anchorage device comprises an anchorage element which has an anchorage section that is arranged to be attached skeletally, that is to say to a bone of the person, for example an upper or lower jaw bone, and also has an attachment section that is arranged to be coupled with the at least one orthodontic element.

Known skeletal anchorage devices comprise anchorage elements designed, for example, in the form of orthodontic bone screws, wherein such orthodontic bone screws are often skeletally anchored only temporarily.

Of the various skeletal anchorage systems and devices, orthodontic bone screws, also known in expert circles as mini pins, mini implants, etc., have largely prevailed owing to their low surgical invasiveness and relatively low cost.

For example, the Straumann® Orthosystem is a known two-part orthodontic implant system in which the implant has, at least in certain sections, an active rough implant surface which osseointegrates (ossifies) in the implanted state. This implant system is problematic when the implant designed in the form of a bone screw can no longer be unscrewed owing to the osseointegration. As in a conventional dental implant system, what are referred to as abutments or attachments of various kinds can be screwed in this system onto the implant that has been screwed in or inserted, that is to say onto the bone screw, in order to couple the orthodontic element for the orthodontic treatment. Accordingly, the abutment acts as an interlink between the bone screw head and the orthodontic element for the orthodontic treatment.

In addition to the high financial cost and the high surgical and organizational complexity of this Orthosystem, a healing time of about three months must also be expected.

As a result, numerous single-piece, temporary, orthodontic, self-cutting, self-drilling bone screws, what are referred to as mini pins or mini implants, with polished implant surfaces, such as the Dual-Top® screw from Promedia, have prevailed in orthodontics. The advantage of such orthodontic bone screws is the low surgical complexity of their insertion. These single-piece bone screws are also much easier to remove because they do not osseointegrate (ossify) and are therefore easy to unscrew or remove.

As this kind of bone screw is basically a single piece, these bone screws are distinguished by the different shapes of their screw heads. The orthodontic elements can then be attached to these various screw heads for the orthodontic treatment. The orthodontic element is usually attached to the screw head for the orthodontic treatment by a plug connection which is secured by means of a tension wire, a wire ligature or a rubber ligature. In the case of the plug connection of the orthodontic element to the screw head of the bone screw for the orthodontic treatment, the reliability of the connection may be problematic because it can easily come loose under certain circumstances.

A two-piece bone screw is used in the BENEFIT system from Mondeal®. This does not osseointegrate because it has a completely polished surface. One characteristic of this bone screw is the screw connection of the bone screw or bone screw head to the abutment or attachment in order to couple the orthodontic element for the orthodontic treatment. The abutment or attachment is attached to the bone screw head in this system by means of a fixing screw. In particular, the abutment or attachment is formed in this system by a plate or a cap which is attached to the bone screw head by means of the additional fixing screw. For example, the connection of the orthodontic element for the orthodontic treatment to the abutment can be produced through a welded connection or a plug connection. In the case of a plug connection, the orthodontic element for the orthodontic treatment is secured by means of a tension wire, a wire ligature or a rubber ligature. However, for manufacturing reasons, this system is extremely complex and therefore expensive.

The invention is therefore based on the object of overcoming at least some of the disadvantages of the anchorage devices belonging to the prior art, in particular the known bone screws. In particular, the object of the invention is to provide an inexpensive orthodontic anchorage device that can be inserted and removed easily compared to the prior art.

This object is achieved by a skeletal anchorage device according to claim 1. Advantageous arrangements and embodiments of the invention are provided in the dependent claims.

The skeletal anchorage device according to the invention for attaching at least one orthodontic element to be used for orthodontic treatment comprises an anchorage element which has an anchorage section that is arranged to be attached skeletally to an upper or lower jaw bone of the person, and also has an attachment section that is arranged to be coupled with the at least one orthodontic element, preferably immediately or directly, wherein the attachment section is provided with an attachment arrangement that is designed such that the orthodontic element may be clamped to the attachment section with continually adjustable clamping force at least in certain sections. The anchorage section of the anchorage element designed as a bone screw is preferably provided with a partially semi-active surface so that the feature and option of unscrewing the screw easily if required does not become lost. Such an anchorage element designed as a bone screw is intended, in particular, to hold, for example by means of clamping, orthodontic elements to be used for orthodontic treatment, for example wire elements or springs, directly or immediately, that is to say without any abutment (or attachment) inserted in between. The anchorage element designed in the form of a bone screw is therefore designed as a single piece so that the orthodontic element to be used for orthodontic treatment does not have to be screwed on by means of the abutment or the attachment, but is plugged in directly and secured, for example, by means of an attachment element designed as a nut. The nut securely clamps the orthodontic element to be used for orthodontic treatment with adjustable clamping force and is therefore not to be attached by means of a separate tension wire or a rubber band. Orthodontic elements to be used for orthodontic treatment, such as round or square wire, can preferably be clamped to the attachment element of the anchorage device according to the invention. Round wires preferably have a diameter of approximately 0.6 mm to 1.1 mm here, while square wires usually have dimensions of no more than about 0.9 mm×0.9 mm. The round wire or square wire is particularly preferably attached directly to the anchorage element designed as a bone screw, in particular to the screw head, by means of a screwable connection which can produce a clamping effect. An interlink such as the abovementioned abutment is therefore no longer necessary. The implantable part of the bone screw, that is to say the anchorage section thereof, is preferably formed through the screw shaft with a suitable external thread that may have an already proven self-cutting, self-drilling thread with a partially semi-active surface.

The skeletal anchorage device according to the invention may advantageously be refined such that the attachment arrangement is designed such that the orthodontic element may be clamped between a receiving section of the attachment section and an attachment element that may be coupled to the attachment section, wherein the receiving section and the attachment element are designed such that the clamping force can be continually adjusted as a function of a change in their position relative to one another.

The skeletal anchorage device according to the invention may also be realized such that the receiving section and the attachment element that may be coupled to the attachment section are designed such that the clamping force can be continually adjusted by rotating the receiving section relative to the attachment element.

The skeletal anchorage device according to the invention may also be produced such that the anchorage device comprises an anchorage element designed in the form of a bone screw, which anchorage element has an anchorage section that is designed in the form of a screw shaft and is arranged to be attached skeletally, preferably by means of an external thread, and also has an attachment section that is designed in the form of a screw head adjoining the screw shaft and is arranged to be coupled with the at least one orthodontic element, wherein the attachment section designed in the form of the screw head is provided with an attachment arrangement that is designed such that the orthodontic element may be clamped at least in certain sections with continually adjustable clamping force between a recess in the screw head acting as a receiving section and a nut screwed onto an external thread of the screw head and acting as an attachment element.

The skeletal anchorage device according to the invention may also be realized such that the recess in the screw head is preferably designed as a slot passing through the screw head and/or the depth direction of the recess runs parallel to the screw axis and/or the recess runs in a straight line through the screw axis.

A preferred embodiment of the invention is explained hereinbelow by reference to the figures, in which:

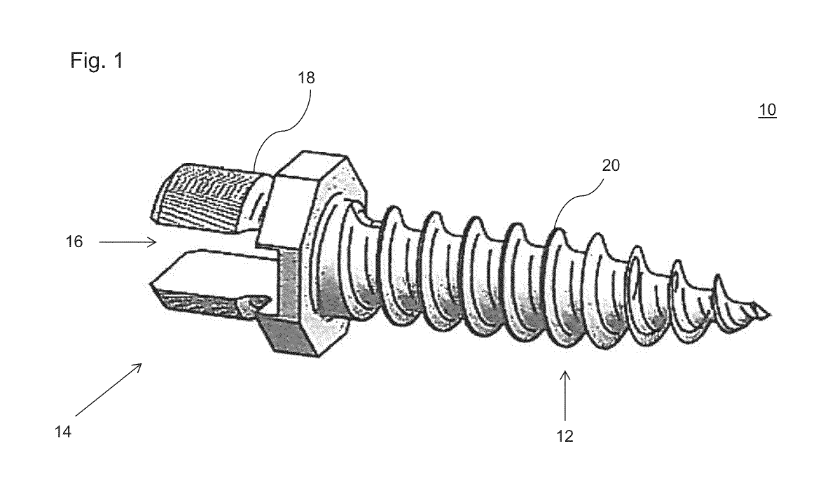

FIG. 1 shows a perspective representation of an orthodontic anchorage device according to the invention;

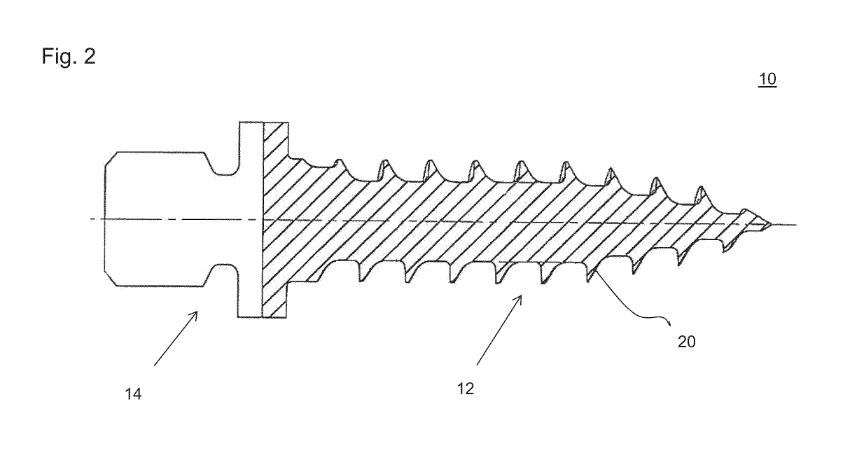

FIG. 2 shows a representation of a sectional view of the orthodontic anchorage device according to the invention shown in FIG. 1 in longitudinal section;

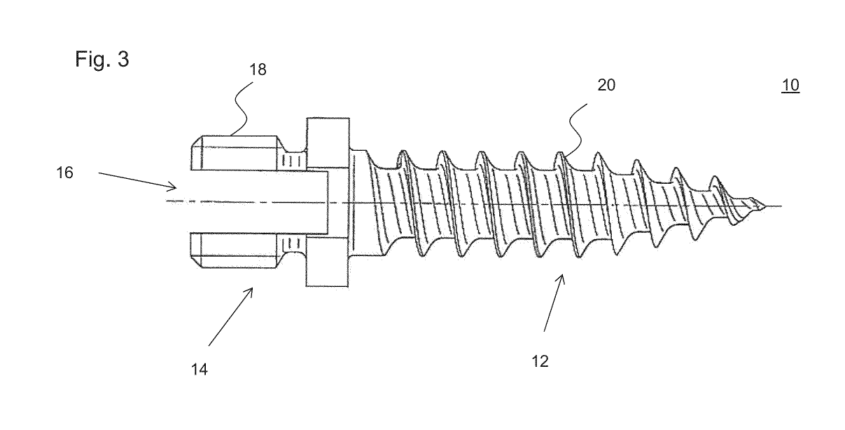

FIG. 3 shows a further representation of the orthodontic anchorage device according to the invention shown in FIG. 1;

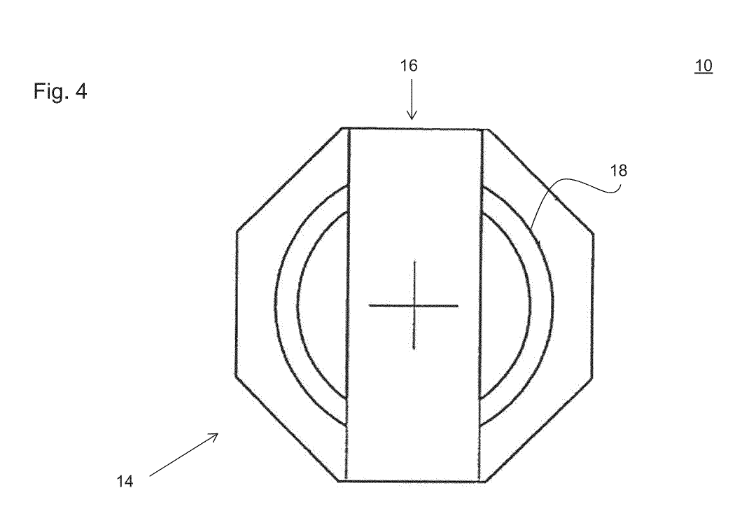

FIG. 4 shows a further representation of the orthodontic anchorage device according to the invention shown in FIG. 1 in plan view; and

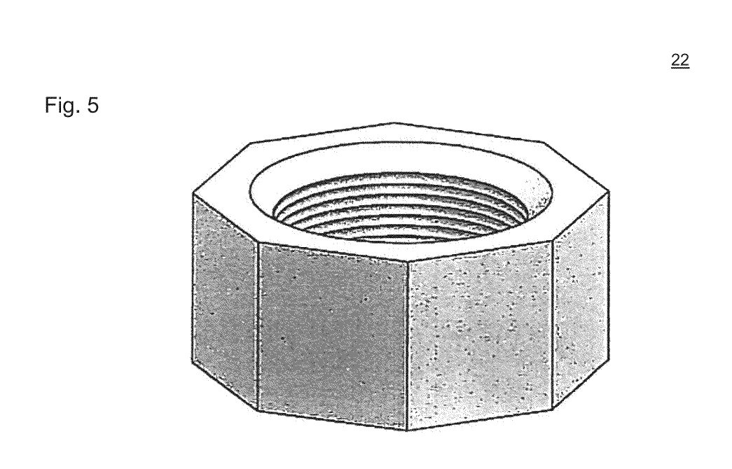

FIG. 5 shows a perspective representation of an attachment element of the orthodontic anchorage device according to the invention shown in FIG. 1.

FIGS. 1 to 4 show a skeletal anchorage device according to the invention for attaching at least one orthodontic element to be used for orthodontic treatment. As can be seen, in particular, in FIGS. 1 to 4, the anchorage device according to the invention comprises an anchorage element 10 which has an anchorage section 12 that is arranged to be attached skeletally, for example to an upper or lower jaw bone. The anchorage element 10 also has an attachment section 14 that is arranged to be coupled with the at least one orthodontic element for the orthodontic treatment. For example, the orthodontic element may be formed by a round or square dental brace wire. The attachment section 14 is also provided with an attachment arrangement that is designed such that the orthodontic element may be clamped to the attachment section 14 with continually adjustable clamping force at least in certain sections. In particular, the attachment arrangement is designed such that the orthodontic element may be clamped between a receiving section 16 of the attachment section 14 and an attachment element 22 that may be coupled with the attachment section 14 (see FIG. 5), wherein the receiving section 16 and the attachment element 22 are designed such that the clamping force and/or the distance from the bottom of the recess to the attachment element 22 can be continually adjusted as a function of a change in their position relative to one another, in particular by rotating the receiving section 16 relative to the attachment element 22.

In the example shown, the anchorage device comprises an anchorage element 10 designed in the form of a single-piece bone screw. The bone screw has, on the one hand, the anchorage section 12 that is designed in the form of a screw shaft, wherein the screw shaft is arranged to be attached skeletally by means of an external thread 20 thereof. The bone screw also has the attachment section 14 that is designed in the form of a screw head adjoining the screw shaft and is arranged to be coupled with the at least one orthodontic element. The screw head here is provided with the attachment arrangement that is designed such that the orthodontic element may be clamped with continually adjustable clamping force at least in certain sections between a recess (or slot) in the screw head acting as a receiving section and a nut screwed onto an external thread 18 of the screw head and acting as an attachment element. As can be seen, in particular, in FIGS. 1 to 4, the recess in the screw head is designed as a slot passing through the screw head, wherein a depth direction of the recess runs parallel to the screw axis and the recess runs in a straight line through the screw axis, that is to say centrally through the screw head. In particular, the screw head is such that it also forms a lip with respect to the screw shaft and is designed to be partially cylindrical, the cylindrical axis coinciding with the screw axis. As already mentioned above, the cylindrical screw head is provided with the external thread 18 so that the nut with the corresponding internal thread can be rotated onto or screwed onto the screw head. The lip is designed such that it can be brought into contact in a form-fitted and/or force-fitted manner with a tool for rotating the bone screw. In the example shown, the lip is designed as an octagonal lip.

As intended, the bone screw is first attached skeletally by means of the anchorage section 12 thereof, in particular the external thread thereof, for example to an upper or lower jaw, specifically by placing a tool on the lip, for example an orthodontic fitting tool such as a wrench, in particular a box wrench, open-end wrench, open-jaw wrench, socket wrench or pipe wrench, etc., and by turning the tool. The orthodontic element, for example the round wire of a dental brace, is then inserted into the gap or recess in the screw head of the bone screw and clamped by turning the nut with a corresponding clamping force.

The anchorage element 10 designed as a bone screw preferably has an axial overall length which lies between 11 mm and 17 mm, the entire screw head (together with the attachment section and lip) preferably having a length here of 3 mm and the anchorage section designed as a screw shaft preferably having an overall length here that lies between 8 mm and 14 mm in the axial direction. The lip preferably has a length here of 0.8 mm in the axial direction. The slot is preferably 1.2 mm wide and 2.6 mm deep in the axial direction, the lip preferably having a diameter of 3.2 mm from a circumferential surface of the lip delimited by two edges to an opposite circumferential surface of the lip.

Particularly preferred pairings of bone screw total length/screw shaft total length are as follows: 11 mm/8 mm, 13 mm/10 mm, 15 mm/12 mm, and 17 mm/14 mm.

The features of the invention disclosed in the above description, in the drawings and in the claims may be essential to the realizing of the invention both individually and in any desired combination.

1. Skeletal anchorage device for attaching at least one orthodontic element to be used for orthodontic treatment, wherein the anchorage device comprises an anchorage element (10) which has an anchorage section (12) that is arranged to be attached skeletally to an upper or lower jaw bone of the person, and also has an attachment section (14) that is arranged to be coupled with the at least one orthodontic element, wherein the attachment section (14) is provided with an attachment arrangement that is designed such that the orthodontic element may be clamped to the attachment section (14) with continually adjustable clamping force at least in certain sections.

2. Skeletal anchorage device according to claim 1, wherein the attachment arrangement is designed such that the orthodontic element may be clamped between a receiving section (16) of the attachment section (14) and an attachment element (22) that may be coupled to the attachment section (14), wherein the receiving section (16) and the attachment element (22) are designed such that the clamping force can be continually adjusted as a function of a change in their position relative to one another.

3. Skeletal anchorage device according to claim 2, wherein the receiving section (16) and the attachment element (22) that may be coupled to the attachment section (14) are designed such that the clamping force can be continually adjusted by rotating the receiving section (16) relative to the attachment element (22).

4. Skeletal anchorage device according to claim 1, wherein the anchorage device comprises an anchorage element (10) designed in the form of a bone screw, which anchorage element (10) has an anchorage section (12) that is designed in the form of a screw shaft and is arranged to be attached skeletally, preferably by means of an external thread (20), and also has an attachment section (14) that is designed in the form of a screw head adjoining the screw shaft and is arranged to be coupled with the at least one orthodontic element, wherein the attachment section (14) designed in the form of the screw head is provided with an attachment arrangement that is designed such that the orthodontic element may be clamped at least in certain sections with continually adjustable clamping force between a recess in the screw head acting as a receiving section and a nut screwed onto an external thread (18) of the screw head and acting as an attachment element.

5. Skeletal anchorage device according to claim 1, wherein the recess in the screw head is designed as a slot passing through the screw head and/or the depth direction of the recess runs parallel to the screw axis and/or the recess runs in a straight line through the screw axis and/or the recess runs centrally through the screw head.

6. Skeletal anchorage device according to claim 2, wherein the anchorage device comprises an anchorage element (10) designed in the form of a bone screw, which anchorage element (10) has an anchorage section (12) that is designed in the form of a screw shaft and is arranged to be attached skeletally, preferably by means of an external thread (20), and also has an attachment section (14) that is designed in the form of a screw head adjoining the screw shaft and is arranged to be coupled with the at least one orthodontic element, wherein the attachment section (14) designed in the form of the screw head is provided with an attachment arrangement that is designed such that the orthodontic element may be clamped at least in certain sections with continually adjustable clamping force between a recess in the screw head acting as a receiving section and a nut screwed onto an external thread (18) of the screw head and acting as an attachment element.

7. Skeletal anchorage device according to claim 3, wherein the anchorage device comprises an anchorage element (10) designed in the form of a bone screw, which anchorage element (10) has an anchorage section (12) that is designed in the form of a screw shaft and is arranged to be attached skeletally, preferably by means of an external thread (20), and also has an attachment section (14) that is designed in the form of a screw head adjoining the screw shaft and is arranged to be coupled with the at least one orthodontic element, wherein the attachment section (14) designed in the form of the screw head is provided with an attachment arrangement that is designed such that the orthodontic element may be clamped at least in certain sections with continually adjustable clamping force between a recess in the screw head acting as a receiving section and a nut screwed onto an external thread (18) of the screw head and acting as an attachment element.

8. Skeletal anchorage device according to claim 2, wherein the recess in the screw head is designed as a slot passing through the screw head and/or the depth direction of the recess runs parallel to the screw axis and/or the recess runs in a straight line through the screw axis and/or the recess runs centrally through the screw head.

9. Skeletal anchorage device according to claim 3, wherein the recess in the screw head is designed as a slot passing through the screw head and/or the depth direction of the recess runs parallel to the screw axis and/or the recess runs in a straight line through the screw axis and/or the recess runs centrally through the screw head.

10. Skeletal anchorage device according to claim 4, wherein the recess in the screw head is designed as a slot passing through the screw head and/or the depth direction of the recess runs parallel to the screw axis and/or the recess runs in a straight line through the screw axis and/or the recess runs centrally through the screw head.

11. Skeletal anchorage device according to claim 6, wherein the recess in the screw head is designed as a slot passing through the screw head and/or the depth direction of the recess runs parallel to the screw axis and/or the recess runs in a straight line through the screw axis and/or the recess runs centrally through the screw head.

12. Skeletal anchorage device according to claim 7, wherein the recess in the screw head is designed as a slot passing through the screw head and/or the depth direction of the recess runs parallel to the screw axis and/or the recess runs in a straight line through the screw axis and/or the recess runs centrally through the screw head.
